(19) United States
(12) Patent Application Publication
(10) Pub. No.: US 2011/0079416 A1
(43) Pub. Date: Apr. 7, 2011

(54) Hydrous water absorbent polymer-dispersed ultraviolet curable resin composition, porous substance, and insulated wire cable using the same

(75) Inventors: Yoshihisa Kato, Hitachi (JP); Tomiya Abe, Takahagi (JP); Takao Miwa, Hitachinaka (JP)

(73) Assignee: HITACHI CABLE, LTD., Tokyo (JP)

(21) Appl. No.: 12/659,114

(22) Filed: Feb. 25, 2010

(30) Foreign Application Priority Data
Oct. 1, 2009 (JP) 2009-229718

(51) Int. Cl. H01B 3/30; C09K 3/00; B05D 5/12; B05D 3/06

(52) U.S. Cl. 174/110 SR; 252/194; 427/119; 427/557

(57) ABSTRACT

A hydrous water absorbent polymer-dispersed ultraviolet curable resin composition includes a hydrous water absorbent polymer preliminarily hydrated, swollen and dispersed in the resin composition, and a hydrophilic monomer. The hydrophilic monomer is added not less than 10 mass % to the resin composition.

The present application is based on Japanese Patent Application No. 2009-229718 filed on Oct. 1, 2009, the entire contents of which are incorporated herein by reference.

### BACKGROUND OF THE INVENTION

1. Field of the Invention

The invention relates to a hydrous water absorbent polymer-dispersed ultraviolet curable resin composition for forming an insulation layer formed of a porous film, a porous substance and an insulated wire cable using the same.

2. Description of the Related Art

In recent years, in accordance with downsizing or high-density mounting of precision electronic devices or communication devices in medical and other fields, a diameter of a wire/cable used for those devices is more and more reduced. Furthermore, the trend of further high-speed transmission signal is remarkable for a signal line, etc., and it is desired to speed up the transmission signal by thinning an insulation layer of a wire used therefor and decreasing dielectric constant as much as possible.

A foamed insulating material having low dielectric constant such as a polyethylene or fluorine resin is used for a conventional insulation layer. A method in which a pre-foamed film is formed on a conductor or an extrusion method is known for forming a foamed insulation layer, and especially the extrusion method is widely used.

A foam forming method is roughly classified into a physical foaming method and a chemical foaming method.

The physical foaming method includes a method in which a volatile foaming liquid such as liquefied chlorofluorocarbon is injected into a molten resin to make foams by the vaporization pressure, or a method in which a foaming gas such as nitrogen gas or carbon dioxide gas is directly injected into a molten resin in an extruder to generate uniformly-distributed cellular fine independent foam body in the resin (JP-A 2003-26846).

The chemical foaming method is well known in which formation is carried out in a state that an foaming agent is dispersively mixed in the resin, a decomposition reaction of the foaming agent is subsequently generated by applying heat, and foams are produced by using gas generated by the decomposition (JP-A 11-176262 and JP-A 62-236837).

However, in the method of injecting the volatile foaming liquid into the molten resin, the vaporization pressure is high and fine formation or uniform formation of foams is difficult, thus, there is a limit to thin formation. In addition, since the injection speed of the volatile foaming liquid is slow, there is a problem such that it is difficult to increase the production speed and the productivity is inferior. Furthermore, in the method of directly injecting the foaming gas in the extruder, since there is a limit to a small-diameter thin extrusion and a special facility or technology is required for safety, there is a problem that the productivity is inferior and the production cost increases.

On the other hand, the chemical foaming method has a problem such that, since the foaming agent is preliminarily kneaded an dispersively mixed in the resin and is then foamed by a gas which is generated by reacting and decomposing the foaming agent by heat after the formation process, there is a problem that the formation process temperature of the resin needs to be kept lower than the decomposition temperature of the foaming agent. Furthermore, when a diameter of wire is small, there is another problem in an extrusion coating such that the wire breakage is likely to occur and it is thus difficult to increase speed.

In addition, there are problems that environmental load of the physical foaming method using chlorofluorocarbon, butane and carbon dioxide gases etc., is high and that the foaming agent used for the chemical foaming method is expensive.

### SUMMARY OF THE INVENTION

It is an object of the invention to provide a hydrous water absorbent polymer-dispersed ultraviolet curable resin composition which is environmentally friendly, facilitates formation of uniform fine pores and can be easily applied to reduce a diameter and to thin a film, a porous substance and an insulated wire cable using the same.

(1) According to one embodiment of the invention, a hydrous water absorbent polymer-dispersed ultraviolet curable resin composition comprises:

a hydrous water absorbent polymer preliminarily hydrated, swollen and dispersed in the resin composition; and

a hydrophilic monomer,

wherein said hydrophilic monomer is added not less than 10 mass % to the resin composition.

In the above embodiment (1), the following modifications and changes can be made.

(i) The hydrous water absorbent polymer is dispersed so that a moisture content of the resin composition is not less than 30 mass %.

(ii) The hydrophilic monomer comprises at least one selected from vinyl pyrrolidone, N,N-dimethylaminoethyl methacrylate, 2-hydroxyethyl acrylate, 2-hydroxyethyl methacrylate and hydroxypropyl acrylate.

(iii) The hydrous water absorbent polymer is treated to be not more than 30 μm in a particle diameter or a formed pore size.

(2) According to another embodiment of the invention, a porous substance is formed by cross-link curing the hydrous water absorbent polymer-dispersed ultraviolet curable resin composition according to the embodiment (1) and subsequently removing moisture therefrom by heating.

In the above embodiment (2), the following modifications and changes can be made.

(iv) A microwave heating is used as the heating.

(3) According to another embodiment of the invention, an insulated wire comprises:

an insulation layer formed by coating an outer periphery of a conductor with the hydrous water absorbent polymer-dispersed ultraviolet curable resin composition according to claim 1, and after curing the resin composition, heating the cured resin composition for removing moisture therein.

In the above embodiment (3), the following modifications and changes can be made.

(v) A thickness of the insulation layer is not more than 100 μm, and a porosity thereof is 20% to 60%.

(vi) A cross section of the pore that forms a void in the insulation layer is in a substantially circular shape, a ratio of a maximum diameter portion thereof and a minimum diameter portion is not more than 2, and a pore size D in a thickness direction is formed so as to be D<1/2t where a thickness of the insulation layer is t.

(vii) The insulated wire further comprises a skin layer provided on an outer periphery of the insulated wire.

(4) According to another embodiment of the invention, a coaxial cable comprises:

a metal layer provided on an outer periphery of the insulated wire according to the embodiment (3).

(5) According to another embodiment of the invention, a method of manufacturing an insulated wire comprises:

coating an outer periphery of a conductor with the hydrous water absorbent polymer-dispersed ultraviolet curable resin composition according to the embodiment (1); and

after forming an insulation layer by curing the resin composition, heating the cured resin composition for removing moisture, thereby forming pores in the insulating film.

In the above embodiment (5), the following modifications and changes can be made.

(viii) A microwave heating is used as the heating.

### POINTS OF THE INVENTION

According to one embodiment of the invention, at least one of hydrophilic monomers is used for a hydrous water absorbent polymer-dispersed ultraviolet curable resin composition. It is used to obtain sufficient film-forming properties when increasing the moisture content the resin composition. If the hydrophilic monomer is not contained, it is difficult to increase the moisture content and the film-forming properties significantly decrease. The reason why a ratio of the hydrophilic monomer in the ultraviolet curable resin composition is not less than 10 mass % is as follows. An effect of film-forming properties is not obtained at less than 10 mass % when the moisture content is increased by dispersing the hydrous water absorbent polymer. The upper limit of the ratio of the hydrophilic monomer is not specifically limited, however, 50 mass % or less is desirable. It is because, even if the value is above this, an effect in the film-forming properties is reduced and it becomes difficult to obtain a property balance such as flexibility or mechanical characteristics.

### BRIEF DESCRIPTION OF THE DRAWINGS

Next, the present invention will be explained in more detail in conjunction with appended drawings, wherein:

FIG. 1 is a horizontal cross sectional view showing an insulated wire in a preferred embodiment of the present invention, in which an insulation layer is formed of a porous substance;

FIG. 2 is a horizontal cross sectional view showing a multilayer covered cable using the insulated wire in the embodiment of the invention;

FIG. 3 is a horizontal cross sectional view showing a coaxial cable using the insulated wire in the embodiment of the invention; and

FIG. 4 is a microscope photograph showing a 500-times enlarged cross section of a 100 μm thick film obtained at moisture content of 40 mass % in Example 1 of the invention.

### DESCRIPTION OF THE PREFERRED EMBODIMENTS

The embodiment of the invention will be described below with reference to the appended drawings.

Firstly, an insulated wire, a multilayer covered cable and a coaxial cable to which a hydrous water absorbent polymer-dispersed ultraviolet curable resin composition of the invention is applied will be explained by FIG. 1-3.

FIG. 1 is a horizontal cross sectional view of an insulated wire. An insulated wire 10 is formed by coating an outer periphery of plural conductors 3 with an insulation layer 1 formed of a hydrous water absorbent polymer-dispersed ultraviolet curable resin composition having fine pores 2.

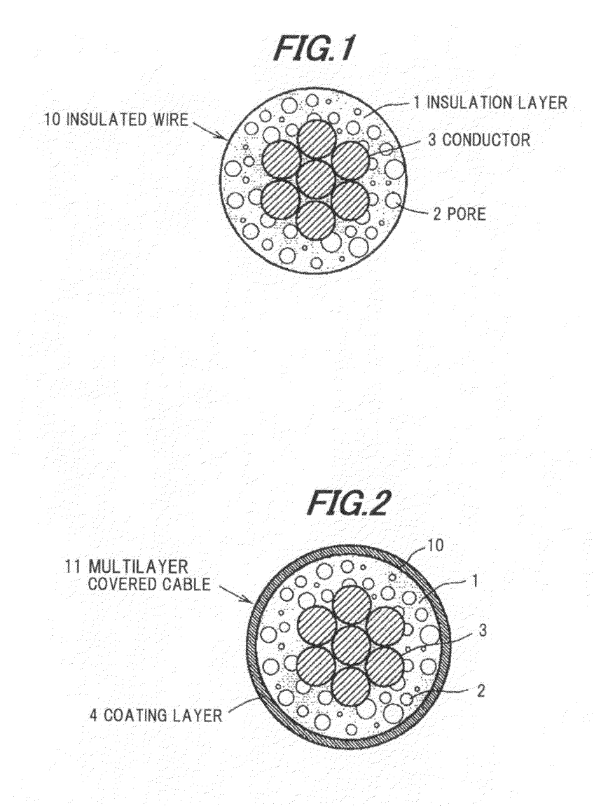

FIG. 2 is a horizontal cross sectional view of a multilayer covered cable using the insulated wire 10 shown in FIG. 1. A multilayer covered cable 11 is formed by forming a skin layer or a coating layer 4 on an outer periphery of the insulated wire 10.

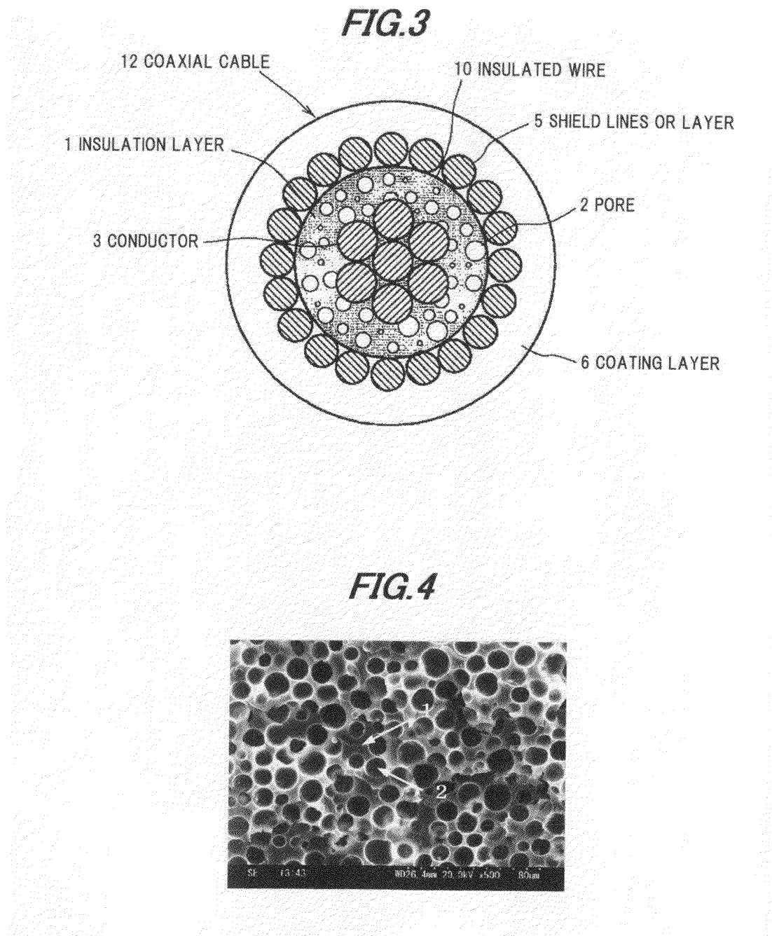

FIG. 3 is a horizontal cross sectional view of a coaxial cable using the insulated wire 10 shown in FIG. 1. Shielded lines or shield layers 5 are formed on an outer periphery of the insulation layer 1 of the insulated wire 10 using the conductor 3 of the insulated wire 10 as an inner conductor, and a coating layer 6 is formed on a further outer periphery thereof, thereby forming a coaxial cable 12.

The invention is to form an insulation layer by dispersing a hydrous water absorbent polymer preliminarily hydrated and swollen in an ultraviolet curable resin composition with addition of 10 mass % or more of at least one or more of hydrophilic monomers to the ultraviolet curable resin composition.

In addition, the hydrous water absorbent polymer is dispersed so that the moisture content in the hydrous water absorbent polymer-dispersed ultraviolet curable resin composition is 30 mass % or more.

The ultraviolet curable resin composition is cured by ultraviolet rays, a well-known resin composition such as ethylene-system, urethane-system, silicone-system, fluorine-system, epoxy-system, polyester-system, polycarbonate-system can be selected, and a resin composition has a dielectric constant of 4 or less, preferably 3 or less.

The water absorbent polymer is a polymer material that absorbs water very well and does not discharge absorbed water due to its high water-holding ability even when some pressure is applied. For example, hydrolysate of starch-acrylonitrile graft polymer, starch-acrylic acid graft polymer, a hydrolysate of vinyl acetate-acrylic acid ester copolymer, cross-linked polyacylate, carboxymethylated cellulose, polyalkylene oxide system resin and polyacrylamide system resin etc., are included.

The hydrous water absorbent polymer is a water absorbent polymer with water absorbed therein. The reason why the water absorbent polymer with the absorbed water is dispersed is that, since the size and shape of the pore can be controlled by the particle diameter of the water absorbent polymer and the amount of water absorption, the water absorbent polymer which is gelled by the water absorbing and swelling contains much water and the liquid ultraviolet curable resin composition is not compatible with water, it is easily independently dispersed and easily dispersed by forming a sphere shape when being agitated and dispersed. Thus, the pore shape obtained by dehydration after curing can be close to a spherical shape and the resistance to the collapse is likely to be obtained.

Especially, it is preferable that the water absorbent polymer does not contain sodium and the amount of water absorption thereof is 20 g/g or more. The polyalkylene oxide system resin is most representative. The reason why sodium is not contained is that it is likely to cause a decrease in electrical insulating properties. The amount of water absorption is an amount of water (g) absorbed per 1 g of water absorbent polymer, and when the amount of water absorption is smaller than 20 g/g, pore formation efficiency decreases and it is necessary to use many water absorbent polymers.

The reason why at least one or more hydrophilic monomers are used for the hydrous water absorbent polymer-dispersed ultraviolet curable resin composition is to obtain film-forming properties when increasing the moisture content. When the hydrophilic monomer is not contained, it is difficult to increase the moisture content and the film-forming properties significantly decrease.

The reason why a ratio of the hydrophilic monomer in the ultraviolet curable resin composition is 10 mass % or more is that an effect of film-forming properties is not obtained at less than 10 mass % when the moisture content is increased by dispersing the hydrous water absorbent polymer. The upper limit of the ratio of the hydrophilic monomer is not specifically limited, however, 50 mass % or less is desirable. It is because, even if the value is above this, an effect in the film-forming properties is reduced and it becomes difficult to obtain a property balance such as flexibility or mechanical characteristics.

The reason why the moisture content in the ultraviolet curable resin composition with the hydrous water absorbent polymer dispersed therein is 30 mass % or more is that it is difficult to obtain a dielectric constant lower than that of PFA which is thermoplastic resin, fluorine system resin such as ETFE or polyethylene. The upper limit of the ratio of the moisture content is not specifically limited, however, 70 mass % or less is desirable. It is because, if the value is above this, formation of stable porous substance becomes significantly difficult.

The reason of using one or more hydrophilic monomers selected from the group consisting of vinyl pyrrolidone, N,N-dimethylaminoethyl methacrylate, 2-hydroxyethyl acrylate, 2-hydroxyethyl methacrylate and hydroxypropyl acrylate is that it is very effective for obtaining the film-forming properties when the moisture content is increased. Alternatively, depending on the moisture content, it is possible to form a film by another hydrophilic monomer, e.g., by butanediol monoacrylate, t-butylaminoethyl methacrylate, N,N-dimethylaminoethyl acrylate, N,N-diethylaminoethyl acrylate, 2-ethoxyethyl acrylate, n-hexyl acrylate, hydroxypropyl methacrylate, neopentyl glycol diacrylate, polyethylene glycol 400 diacrylate, polypropylene glycol monoacrylate, polyethylene glycol monomethacrylate, tetrahydrofurfuryl acrylate, tetrahydrofurfuryl methacrylate, N-vinyl acetate or vinyl caprolactam, etc.

A particle diameter of the hydrous water absorbent polymer should be 30 μm or less. The reason why the particle diameter is 30 μm or less is that the particle diameter is substantially equal to the obtained pore size and a problem in the mechanical characteristics such as a collapse is likely to occur at greater than 30 μm when a film thickness approximates to the pore size for thinning the film.

The reason for conducting the dehydration by heating after curing by ultraviolet rays is that the reduction in porosity due to the volume contraction by the dehydration can be prevented and the change in film thickness or outer diameter can be prevented, thereby obtaining the stabilization. Furthermore, since the coating can be formed preliminarily including portions to be pores, it is not necessary to foam and reduction in adhesiveness is not caused by swelling or separation between the conductor and the foamed layer which may occur in the conventional gas foaming process by gas injection or foaming agent, thereby obtaining the stabilization.

The reason why microwave heating is used for thermal dehydration of water in the water absorbent polymer with the absorbed water is that, since the water is rapidly heated by microwave, the thermal dehydration is possible in short time and a pore is thereby efficiently formed without affecting the water absorbent polymer or the peripheral resin. In addition, continuous thermal dehydration is possible by using a waveguide microwave furnace.

The hydrous water absorbent polymer-dispersed ultraviolet curable resin composition can be used with addition of, according to need, a dispersing agent, a leveling agent, a coupling agent, a coloring agent, a flame retardant, an antioxidant, an electrical insulation improver or a filler etc. which are conventionally known.

The reason why the insulated wire has an insulation layer having a thickness of 100 μm or less and a porosity of not less than 20% nor more than 60%, the pore to be formed is in a spherical shape, the ratio of the maximum diameter portion and the minimum diameter portion is 2 or less and a pore size D in a thickness direction to the insulation layer thickness t is set to be D<1/2t is that a small diameter and high-speed transmission signal are being developed for a coaxial cable as typified by a medical probe cable in which thinning an insulation layer and decreasing dielectric constant are essential and that the pore formation is effective for lowering the dielectric constant of the insulation layer. However, a problem occurs in which, when the porosity is too high or the pore size is too large, the insulation layer is likely to be collapsed and a stable signal transmission is not obtained, hence, it is for obtaining an insulated wire which is thin, low in dielectric constant and excellent in crush resistance.

The reason why the porosity is not less than 20% nor more than 60% is that the low dielectric constant effect is insufficient when the porosity is less than 20% and formability and crush resistance, etc., of the insulation layer are likely to be reduced when the porosity exceeds 60%.

The reason why the ratio of the maximum diameter portion and the minimum diameter portion is 2 or more is that the collapse is likely to occur when larger than 2.

The reason why the a pore size D in a thickness direction to the insulation layer thickness t is set to be D<1/2t is that there is a problem in that the higher the porosity is, the more likely it is that the collapse occurs when larger than 1/2t.

In the water absorbent polymer, since the size or shape of the pore can be adjusted by the particle diameter and the amount of water absorption of the water absorbent polymer, furthermore, since the insulation layer can be formed in a state that the portions to be pores are preliminarily formed in the composition, it is possible to facilitate the control.

### Examples

Examples 1 to 7 and Comparative Examples 1 to 6 will be described below

Table 1 shows ultraviolet curable resin compositions used in Examples 1 to 7 and Comparative Examples 1 to 6.

TABLE 1

| | | | Examples | | | | | | | Comparative Examples | | | | | |
|---|---|---|---|---|---|---|---|---|---|---|---|---|---|---|---|
| | | | 1 | 2 | 3 | 4 | 5 | 6 | 7 | 1 | 2 | 3 | 4 | 5 | 6 |
| Ultraviolet curable | Urethane acrylate *1 | | 100 | 100 | 100 | 100 | 100 | 100 | 100 | 100 | 100 | 100 | 100 | 100 | 100 |
| resin composition | Dicyclopentanyl | | 20 | 15 | 10 | 15 | 15 | 15 | 15 | 40 | 25 | 25 | 25 | 20 | 15 |
| | methacrylate *2 | | | | | | | | | | | | | | |
| | Isobornyl methacrylate *3 | | 10 | 10 | 5 | 10 | 10 | 10 | 10 | 10 | 10 | 10 | 10 | 10 | 10 |
| | Hydrophilic monomer | A *4 | 20 | 25 | 25 | | | | | | 15 | | | | |
| | | B *5 | | | | 25 | | | | | | 15 | | | |
| | | C *6 | | | 10 | | 25 | | | | | | 15 | | |
| | | D *7 | | | | | | 25 | | | | | | 15 | |
| | | E *8 | | | | | | | 25 | | | | | | 15 |
| | 1-hydroxy cyclohexyl | | 2 | 2 | 2 | 2 | 2 | 2 | 2 | 2 | 2 | 2 | 2 | 2 | 2 |
| | phenylketone *9 | | | | | | | | | | | | | | |
| | 2,4,6-trimethyl | | 3 | 3 | 3 | 3 | 3 | 3 | 3 | 3 | 3 | 3 | 3 | 3 | 3 |
| | benzoyldiphenyl phosphine | | | | | | | | | | | | | | |
| | oxide *10 | | | | | | | | | | | | | | |
| Total | | | 155 | 155 | 155 | 155 | 155 | 155 | 155 | 155 | 155 | 155 | 155 | 155 | 155 |
| Ratio of hydrophilic monomer (mass %) | | | 12.9 | 16.1 | 22.6 | 16.1 | 16.1 | 16.1 | 16.1 | 0 | 9.7 | 9.7 | 9.7 | 9.7 | 9.7 |
| Film-forming | Dispersed moisture content | 25 | ◯ | ◯ | ◯ | ◯ | ◯ | ◯ | ◯ | ◯ | ◯ | ◯ | ◯ | ◯ | ◯ |
| properties | of hydrous water absorbent | 30 | ◯ | ◯ | ◯ | ◯ | ◯ | ◯ | ◯ | X | Δ | Δ | Δ | X | Δ |
| t = 100 μm | polymer (mass %) (water | 40 | ◯ | ◯ | ◯ | ◯ | ◯ | ◯ | ◯ | X | X | X | X | X | X |
| | absorbent polymer:water = | 50 | ◯ | ◯ | ◯ | ◯ | ◯ | ◯ | ◯ | X | X | X | X | X | X |
| | 1:31) | 60 | X | ◯ | ◯ | ◯ | ◯ | ◯ | ◯ | X | X | X | X | X | X |
| Porosity after | Dispersed moisture content | 25 | 24 | 24.5 | 24.4 | 24.3 | 24 | 23.5 | 24.2 | 21.4 | 24.1 | 23.8 | 23.7 | 24 | 23.1 |
| thermal | of hydrous water absorbent | 30 | 28.8 | 29.1 | 28.5 | 28.3 | 28.1 | 27.5 | 28 | — | — | — | — | — | — |
| dehydration | polymer (mass %) (water | 40 | 31.9 | 39.2 | 38.9 | 38.5 | 38.7 | 37.6 | 38.1 | — | — | — | — | — | — |
| (%) | absorbent polymer:water = | 50 | 48.1 | 48.5 | 48.6 | 48.3 | 48.2 | 47.9 | 48 | — | — | — | — | — | — |
| | 1:31) | 60 | — | 58 | 57.8 | 57.1 | 56.9 | 56.5 | 57 | — | — | — | — | — | — |

*1 M-1200 manufactured by Toa Gosei Kagaku Kogyo K.K.,
*2 FA-513M manufactured by Hitachi Chemical Co., Ltd.,
*3 IB-X manufactured by Kyoeisha Chemical Co., LTD,
*4 N-vinyl pyrrolidone,
*5 2-hydroxy methacrylate,
*6 hydroxypropyl acrylate,
*7 N,N-dimethylaminoethyl methacrylate,
*8 2-hydroxyethyl acrylate,
*9 IRGACURE ® 184 manufactured by Ciba Specialty Chemicals K.K.,
*10 DAROCUR ® TPO manufactured by Ciba Specialty Chemicals K.K.

Urethane acrylate was used as an ultraviolet curable resin composition, dicyclopentanyl methacrylate and isobornyl methacrylate were used as a reactive diluents, and 1-hydroxy cyclohexyl phenylketone and 2,4,6-trimethyl benzoyldiphenyl phosphine oxide were used as a photopolymerization initiator, then, hydrophilic monomers A-E were added thereto.

A water absorbent polymer formed of polyalkylene oxide system resin (AQUACALK TWB-PF, manufactured by Sumitomo Seika Chemicals Co., Ltd.) with preliminarily absorbed distilled water of which water absorption ratio is 31 parts by weight of the distilled water per 1 part by weight of the water absorbent polymer, which is cracked at a pressure of 100 MPa using a homogenizer PA-2K (manufactured by Niro Soavi) so that a particle diameter of the hydrous water absorbent polymer is 30 μm or less, is dispersed as a hydrous water absorbent polymer in the ultraviolet curable resin composition with the added hydrophilic monomer.

The hydrous water absorbent polymer was heated to 50° C., was added to each ultraviolet curable resin composition preheated to 50° C. so that the moisture content are 25, 30, 40, 50 and 60 mass %, and was agitated and dispersed at a rotation speed of 300 rpm for 30 minutes by an agitator (Three-One Motor).

A 100 μm thick coating film having a width of 100 mm and a length of 20 mm was formed on a glass plate using a 7 MIL blade and radiation was carried out at 1000 mJ/cm² under a nitrogen atmosphere by using a UV irradiation conveyer (metal halide lamp with 80 W/cm of output), and whether or not a film is formed was thereby confirmed.

The film-forming properties are evaluated as O for a perfect film, Δ for an imperfect film and X in case that a film is not formed at all.

After the dehydration of the obtained film by heating for 10 minutes using a microwave heating apparatus (with oscillation frequency of 2.45 GHz), the condition was adjusted at 23±2° C., 55% RH for 24 hours, volume and weight were subsequently measured, and the porosity was derived from the following formula.

Porosity(%)={1−(Weight of sample after dehydration/Volume of sample after dehydration)/(Weight of non-hydrated resin sample/Volume of non-hydrated resin sample)}×100.

It was confirmed that, in Examples 1 to 7, the film-forming properties of all films are good (O) and the porosity of the film is in a range of 20-60%.

In contrast, as for Comparative Examples, in the sample not containing the hydrophilic monomer (Comparative Example 1) and in Comparative Examples 2 to 6 in which a ratio of the hydrophilic monomer to the ultraviolet curable resin composition is less than 10 mass %, it is understood that the film-forming property is good and the porosity is 20% or more when the moisture content is 25 mass %, however, a complete film is not obtained in any Comparative Examples when the moisture content is 30 mass % or more.

From Examples 1 to 7, it is understood that the film-forming properties at 30 mass % of moisture content is dramatically improved by adjusting a ratio of the hydrophilic monomer to be 10 mass % or more.

In addition, the moisture contents in Examples 2 to 7 are increased compared with that of Example 1, and it is understood that the film-forming property is good when the ratio of the hydrophilic monomer is high even though the moisture content is high.

FIG. 4 is a microscope photograph of a 500-times enlarged cross section of a 100 μm thick film obtained at moisture content of 40 mass % in Example 1, and from FIG. 4, it can be confirmed that the pore 2 is formed having a spherical diameter of 30 μm or less.

Therefore, it was confirmed that the pore size D to the insulation layer thickness t (=100 μm) is D<1/2t.

As described for the above Examples 1 to 7 and Comparative Examples 1 to 6, the hydrous water absorbent polymer is dispersed by adjusting the ratio of the hydrophilic monomer in the ultraviolet curable resin composition to be 10 mass % or more, and excellent film-forming properties are thereby obtained even at 30 mass % of moisture content.

Although the insulation layer of the porous film covered wire has been exemplary explained in the above-mentioned embodiment, a porous substance (foamed material) obtained by the hydrous water absorbent polymer-dispersed ultraviolet curable resin composition of the invention can be used for a shock absorbing film (sheet) or a light reflecting plate, etc.

In addition, since the ultraviolet curable resin composition is used, it is possible to form a porous layer on a surface of a deformed object.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A hydrous water absorbent polymer-dispersed ultraviolet curable resin composition, comprising:
a hydrous water absorbent polymer preliminarily hydrated, swollen and dispersed in the resin composition; and
a hydrophilic monomer,
wherein said hydrophilic monomer is added not less than 10 mass % to the resin composition.

2. The hydrous water absorbent polymer-dispersed ultraviolet curable resin composition according to claim 1, wherein said hydrous water absorbent polymer is dispersed so that a moisture content of the resin composition is not less than 30 mass %.

3. The hydrous water absorbent polymer-dispersed ultraviolet curable resin composition according to claim 1, wherein said hydrophilic monomer comprises at least one selected from vinyl pyrrolidone, N,N-dimethylaminoethyl methacrylate, 2-hydroxyethyl acrylate, 2-hydroxyethyl methacrylate and hydroxypropyl acrylate.

4. The hydrous water absorbent polymer-dispersed ultraviolet curable resin composition according to claim 1, wherein the hydrous water absorbent polymer is treated to be not more than 30 μm in a particle diameter or a formed pore size.

5. A porous substance, formed by cross-link curing the hydrous water absorbent polymer-dispersed ultraviolet curable resin composition according to claim 1 and subsequently removing moisture therefrom by heating.

6. The porous substance according to claim 5, wherein a microwave heating is used as the heating.

7. An insulated wire, comprising:
an insulation layer formed by coating an outer periphery of a conductor with the hydrous water absorbent polymer-dispersed ultraviolet curable resin composition according to claim 1, and after curing the resin composition, heating the cured resin composition for removing moisture therein.

8. The insulated wire according to claim 7, wherein a thickness of the insulation layer is not more than 100 μm, and a porosity thereof is 20% to 60%.

9. The insulated wire according to claim 7, wherein a cross section of the pore that forms a void in the insulation layer is in a substantially circular shape, a ratio of a maximum diameter portion thereof and a minimum diameter portion is not more than 2, and a pore size D in a thickness direction is formed so as to be D<1/2t where a thickness of the insulation layer is t.

10. The insulated wire according to claim 7, further comprising:
a skin layer provided on an outer periphery of the insulated wire.

11. A coaxial cable, comprising:
a metal layer provided on an outer periphery of the insulated wire according to claim 7.

12. A method of manufacturing an insulated wire, comprising:
coating an outer periphery of a conductor with the hydrous water absorbent polymer-dispersed ultraviolet curable resin composition according to claim 1; and
after forming an insulation layer by curing the resin composition, heating the cured resin composition for removing moisture, thereby forming pores in the insulating film.

13. The method of manufacturing an insulated wire according to claim 12, wherein a microwave heating is used as the heating.
